(19) United States
(12) Patent Application Publication
(10) Pub. No.: US 2008/0014381 A1
(43) Pub. Date: Jan. 17, 2008

(54) Material of seal and method of making the material

(76) Inventors: Kin Sun Wong, Nan Fung Ind. City (HK); Kam Hung Wan, Nan Fung Ind. City (HK); Hin Wah Wallace Tsang, Nan Fung Ind. City (HK); Kam Kwong Raymond Wan, Nan Fung Ind. City (HK)

Correspondence Address: Raymond Y. Chan;Suite 128, 108 N. Ynez Avenue, Monterey Park, CA, 91754, US

(21) Appl. No.: 11/701,652

(22) Filed: Feb. 2, 2007

(30) Foreign Application Priority Data
Jul. 11, 2006 (CN) 200610061661.0

(51) Int. Cl. D21F 13/00; B41M 5/00

(52) U.S. Cl. 428/32.24; 162/125

(57) ABSTRACT

A seal material has double-layer structure and makes use of the respective virtue of each layer. The seal material includes a lettering layer and an ink seeping layer which superposes and bonds together. The method of making the seal material includes the process of heating both layers' material to squeeze and mold. The seal made with the material of the present invention provides the virtues of higher clarity of impressing, higher speed of ink injection, and without the shortcoming of ink scarcity.

### BACKGROUND OF THE PRESENT INVENTION

1. Field of Invention

The invention relates to a kind of material of seals and a method of making said material, and more particularly to the material with double layers which has virtues of higher clarity of impressing, higher speed of ink injection, and without the shortcoming of ink scarcity.

2. Description of Related Arts

Existing seals which have the function of automatic ink injection are made with the lacunaris material. The seals mentioned above may be used directly without dipping. The seal includes ink injection part and the part of impressing face. When the seal is used, ink in the seal becomes to flow from upside of the seal material to the impressing face. People may impress the paper and so on directly without dipping. It is apparent that using the seal with the function of automatic ink injection is more simple and convenient for people. Now the seal products mentioned above are used by people widely.

The seal mentioned above is made with sensitization material and made by sensitization machines. We call it sensitization seal in practice. With the high speed of the development of the technology in the field of sensitization seal material, many kinds of seal material with different density and basic material bring out. The seal material with high density (i.e. the material having holes with small diameter) has the virtue of higher clarity of impressing, but has the disfigurement of lower speed of ink injection and lower efficiency at the same time. Otherwise, the one with low density has the virtue of higher speed and efficiency of ink injection, but the impression effect thereof is worse.

Now there is a kind of sensitization material with double layers structured by high density material and low density one respectively in the prior art. The seal mentioned above includes lettering layer made with high density material and ink seeping layer made with low density material. The two layers stated above are adhibited to each other by mucosity material. The disfigurement of the aforesaid seal includes low efficiency in producing, complex production flow including daubing of mucosity material between said double layers and adhibiting both ones, and ink scarcity which is resulted by mucosity material jamming the jerkwater holes of the seal material and preventing the ink from flowing from the high density material to the low one. How to overcome the disfigurement becomes the technical problem to be settled on edge.

### SUMMARY OF THE PRESENT INVENTION

In view of the aforesaid disadvantages now present in the prior art, the present invention provides a kind of seal material with the structure of double layers and with the virtues of higher clarity of impressing, higher speed of ink injection, but without the shortcoming of ink scarcity. And the present invention also provides a method of making the material mentioned above.

To attain this, the present invention provides a kind of seal material which comprises lettering layer and ink seeping layer, and the layers thereof bond each other together.

The lettering layer which will face to the material that will be impressed will be enchased, and the ink seeping layer will be used to assimilate and to seep ink to the lettering layer. The lettering layer's density is higher than the ink seeping layer's one.

The lettering layer which is 0.3˜3 millimeter in thickness provides jerkwater holes which are 3˜20 micron in diameter and the lettering layer is 75˜95 percent in the rate of stiletto;

and the seeping layer which is 1˜30 millimeter in thickness provides jerkwater holes which are 20˜150 micron in diameter and the lettering layer is 95˜99 percent in the rate of stiletto.

A method of making seal material compring:

1) mixing the seal framework material to acquire primary mixture, and adding the dissolubility stuffing which are 2˜4 times to the primary mixture in bulk and which comprises grains with the diameter of 200˜800 mesh to acquire the material of lettering layer; and

2) mixing the seal framework material to acquire primary mixture, and adding the dissolubility stuffing which are 3.5˜5 times to the primary mixture in bulk and which comprises grains with the diameter of 30˜100 mesh to acquire the material of ink seeping layer; and

3) making the material of lettering layer and the material of seeping layer bonding each other together and becoming semi-manufactured goods at some temperature; and

4) dissolving the aforesaid dissolubility stuffing with some impregnant; and

5) drying the semi-manufactured goods.

The seal framework material may comprise photosensitive pigment auxiliary and polyolefin, or may comprise photosensitive pigment auxiliary and polymerized resin, and so on. It is much easier to make the lettering layer and ink seeping layer become one by selecting the mixture material mentioned above to make both layers.

There are three methods to acquire the semi-manufactured goods as follows:

No. 1 method of squeezing

The material of ink seeping layer and the material of lettering layer are separated into different conduits of the extrusion machine, and next are squeezed out to a mould, and then are squeezed out from one same meatus of the aforesaid mould with the structure of one layer superposing the other layer, and all the processes mentioned above are carried out at the temperature of 100˜130° C. before the two layers become one. We can adjust the thickness of the lettering layer or the ink seeping layer by adjusting the flux the melting layer material (e.g. adjusting the squeeze pressure) and the caliber of the conduit respectively.

No. 2 method of rolling

The material of ink seeping layer and the material of lettering layer are separated into different conduits of the extrusion machine, and the calefaction part thereof heats both layers' material to a temperature at 100° C.˜130° C., and both layers' material becomes semiliquid. There is a mould at each meatus of the aforesaid conduits. After each layer's material is squeezed into monolayer patch, both layer patches superposing each other are transported and rolled by two rollers, and both layer patches become semi-manufactured goods with the structure of the ink seeping layer superposing the lettering layer. Both layer patches become cooling in the air after they are squeezed out from the jawses of the moulds which makes rolling process successful. We can adjust the thickness of both layers by adjusting the size of the mould squeezing jawses.

After the patches mentioned are acquired, they are transported to one mould to superpose each other. Then we can get the semi-manufactured goods of seal material with the lettering layer and ink seeping layer. The squeezing and molding process is carried out at the temperature of 90° C.˜150° C. which costs 5˜20 minutes. It is much better if the temperature is controlled at 115° C.±5° C. and the time of squeezing and molding process is controlled for 10˜15 minutes. The mould is fixed on the one squeezing and molding machine and we can adjust the pressure of the mould depending on needs.

No. 3 method of moulding

The material of ink seeping layer and the material of lettering layer are laid in perpendicularity order and are leveled off respectively, and then are rolled to become one with the structure of one layer superposing the other layer in one mould; and all the processes are carried out at the temperature of 110° C. to 150° C. before the aforesaid dissolubility stuffing is dissolved, and the process of rolling to molding costs time from ten to twenty minutes. After both layers' material becomes semiliquid, the mould makes the ink seeping layer and lettering layer become semi-manufactured goods of seal material.

We can adjust the adding quantity of both layers' material to acquire different thickness of the ink seeping layer and lettering layer.

The aforesaid dissolubility stuffing may be anhydrous Glauber's salt and the corresponding impregnant mentioned above is water; or

the aforesaid dissolubility stuffing is calcium carbonate and the corresponding impregnant mentioned above is the liquor of hydrochloric acid.

In one further example, the aforesaid primary mixture also comprises antioxidant, nonionic surfactant, and processing auxiliary.

In another further example, the aforesaid semi-manufactured goods are laundered with water before they are dried.

In another further example, the dissolubility stuffing is anhydrous Glauber's salt, and there is no need to launder the patches. The process to dissolve anhydrous Glauber's salt may happen at normal temperature.

It is an objection of the present invention to provide a kind of seal material which comprises a lettering layer and an ink seeping layer without agglutinate layer between them, thereby overcoming the disadvantage of jamming the jerkwater holes of the seal material and having the virtues of higher clarity of impressing of the lettering layer and higher speed of ink injection of the ink seeping layer.

It is an objection of the present invention to provide a method of making the seal material, thereby improving the performance of the seal material, predigesting the process of making seal material and enhance the efficiency.

### BRIEF DESCRIPTION OF THE DRAWINGS

The above and other aspects, features, and advantages of the present invention will be more apparent from the following more particular description thereof, presented in conjunction with the following drawings and Appendix, wherein:

FIG. 1 is a sectional view of the seal material related with the present invention;

FIG. 2 schematically shows the method of making the seal material related with the present invention;

FIGS. 3A and 3B schematically shows the sectional view of the squeezing conduit (5,6) and molding mould related with the tenth example; and FIG. 3B shows the sectional view in A-A direction of squeezing conduit (5,6) and molding mould of FIG. 3A; and the arrowhead of FIGS. 3A and 3B shows the direction of the material squeezing; and FIGS. 3A and 3B also show the material of lettering layer, ink seeping layer and the semi-manufactured goods of the seal material;

FIG. 4 is a sectional view of the double platens (7) molding mould (3,4), squeezing conduit (5,6) of the seventh example; and the arrowhead shows the direction of the material squeezing; and FIG. 4 also shows the material of the lettering layer, ink seeping layer and the semi-manufactured goods of the seal material.

Corresponding reference characters indicate corresponding components throughout the several views of the drawings.

### DETAILED DESCRIPTION OF THE PREFERRED EMBODIMENT

The following description of the presently contemplated best mode of practicing the invention is not to be taken in a limiting sense, but is made merely for the purpose of describing the general principles of the invention. The scope of the invention should be determined with reference to the claims.

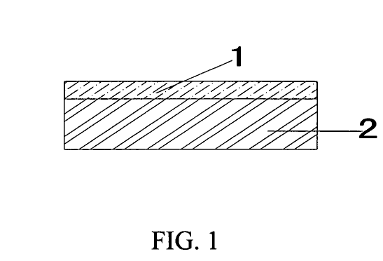

Referring to FIG. 1, the lettering layer 1 is made with high density material and ink seeping layer 2 made with low density is mounted to one side of the lettering layer 1. The thickness of the lettering layer is 0.3˜3 mm and the one is 1˜30 mm for the ink seeping layer. It is convenient to adjust the thickness of the lettering layer and the seeping layer by adjusting the parameter of the squeezing or molding machine and the material delivering quantity. We can acquire the following examples by adjusting the directions for producing chemicals, the size and proportion of dissolubility stuffing of both two layers:

### EXAMPLE 1

The lettering layer 1 provides jerkwater holes which are 3 micron in diameter and the lettering layer is 75 percent in the rate of stiletto;

and the seeping layer 2 provides jerkwater holes which are 21 micron in diameter and the lettering layer is 96 percent in the rate of stiletto;

and both two layers become one.

### EXAMPLE 2

The lettering layer 1 provides jerkwater holes which are 12 micron in diameter and the lettering layer is 85 percent in the rate of stiletto; and the seeping layer 2 provides jerkwater holes which are 85 micron in diameter and the lettering layer is 98 percent in the rate of stiletto; and both two layers become one.

### EXAMPLE 3

The lettering layer 1 provides jerkwater holes which are 20 micron in diameter and the lettering layer is 95 percent in the rate of stiletto; and the seeping layer 2 provides jerkwater holes which are 150 micron in diameter and the lettering layer is 99 percent in the rate of stiletto; and both two layers become one.

### EXAMPLE 4

The lettering layer 1 provides jerkwater holes which are 3 micron in diameter and the lettering layer is 75 percent in the rate of stiletto; and the seeping layer 2 provides jerkwater holes which are 85 micron in diameter and the lettering layer is 98 percent in the rate of stiletto; and both two layers become one.

### EXAMPLE 5

The lettering layer 1 provides jerkwater holes which are 3 micron in diameter and the lettering layer is 75 percent in the rate of stiletto; and the seeping layer 2 provides jerkwater holes which are 150 micron in diameter and the lettering layer is 99 percent in the rate of stiletto; and both two layers become one.

### EXAMPLE 6

The lettering layer 1 provides jerkwater holes which are 12 micron in diameter and the lettering layer is 85 percent in the rate of stiletto; and the seeping layer 2 provides jerkwater holes which are 21 micron in diameter and the lettering layer is 96 percent in the rate of stiletto; and both two layers become one.

### EXAMPLE 7

The lettering layer 1 provides jerkwater holes which are 12 micron in diameter and the lettering layer is 85 percent in the rate of stiletto; and the seeping layer 2 provides jerkwater holes which are 150 micron in diameter and the lettering layer is 99 percent in the rate of stiletto; and both two layers become one.

### EXAMPLE 8

The lettering layer 1 provides jerkwater holes which are 20 micron in diameter and the lettering layer is 95 percent in the rate of stiletto; and the seeping layer 2 provides jerkwater holes which are 21 micron in diameter and the lettering layer is 96 percent in the rate of stiletto; and both two layers become one.

### EXAMPLE 9

The lettering layer 1 provides jerkwater holes which are 20 micron in diameter and the lettering layer is 95 percent in the rate of stiletto; and the seeping layer 2 provides jerkwater holes which are 85 micron in diameter and the lettering layer is 98 percent in the rate of stiletto; and both two layers become one.

The details description for the method of making seal material may be seen from example 10 to 13. The high density layer is lettering layer 1 and the low density one is ink seeping layer 2.

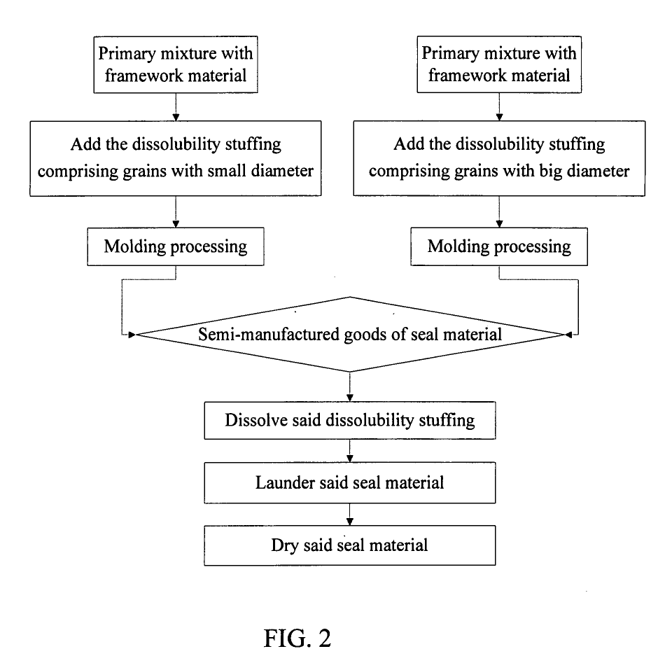

Referring to FIG. 2, the flow of the production is:

In accordance with the directions of producing chemicals we acquire two shares of primary material, and put small quantity of dissolubility stuffing particles with small diameter into one share and mix each other symmetrically to get lettering layer material and put big quantity of dissolubility stuffing particles with big diameter relatively into the other share mix each other symmetrically to get ink seeping layer material. Then, make both layers material become one to get semi-manufactured goods and dissolve the dissolubility stuffing thereof. Next, launder the patch material of the semi-manufactured goods mentioned above and dry it, then we can get the seal material of the present invention.

### EXAMPLE TEN

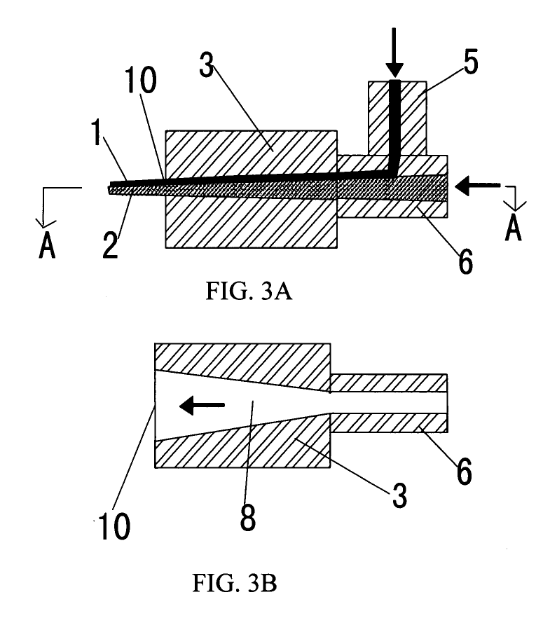

Referring to FIG. 3,

First, mix polyolefin (or polymerized resin), photosensitive pigment auxiliary, antioxidant, nonionic surfactant and processing auxiliary to get primary mixture, and next to mix anhydrous Glauber's salt which is two times to the primary mixture in bulk and is crushed up into 200 mesh, then get new mixture which is called as lettering layer now;

Second, mix polyolefin (or polymerized resin), photosensitive pigment auxiliary, antioxidant, nonionic surfactant and processing auxiliary to get primary mixture, and next to mix anhydrous Glauber's salt which is three and half times to the primary mixture in bulk and is crushed up into 30 mesh, then get new mixture which is called as ink seeping layer now;

Third, put two kinds of new mixture mentioned above into the material container (not showed) of different squeezing conduit 5,6, and heat the aforesaid mixture to a temperature of 110° C.˜120° C. by the heating part of the squeeze machine to make the mixture material become semiliquid.

In operation, make the exit of conduit 5 connect to the conduit 6 to make the different material from different conduit superpose each other. The pressure from the conduit 5,6 respectively make the both material mentioned above squeeze to the exit of the molding mould, and the arrowhead shows the direction of squeezing. The antrum 8 of the molding mould 3 shows cuniform, and referring to FIG. 3A, the perpendicularity size of antrum 8 becomes smaller and smaller in the direction to the exit of antrum 8; and the level size of antrum 8 becomes bigger and bigger in the direction of the arrowhead; thereby, when the lettering layer and the ink seeping layer superposing each other are squeezed to the exit 10 of the antrum 8, both layers become thin and wide. It is apparent that the cuniform structure of the antrum 8 gets it conveniently to make the semi-manufactured goods become patch material.

The semi-manufactured goods of seal material with the structure of ink seeping layer and lettering layer superposing each other and both layers becoming one is produced at the squeezing exit 10 of the molding mould 3. Marinate the anhydrous Glauber's salt for ninety-six hours, and launder the semi-manufactured goods with water at normal temperature and next dry, then we can acquire the seal material related the present invention. In operation, adjust the squeezing pressure or the material adding speed we can adjust the thickness of the lettering layer and ink seeping layer.

### EXAMPLE 11

First, mix polyolefin (or polymerized resin), photosensitive pigment auxiliary, antioxidant, nonionic surfactant and processing auxiliary to get primary mixture, and next to mix anhydrous Glauber's salt which is three times to the primary mixture in bulk and is crushed up into 500 mesh, then get new mixture which is called as lettering layer now;

Second, mix polyolefin (or polymerized resin), photosensitive pigment auxiliary, antioxidant, nonionic surfactant and processing auxiliary to get primary mixture, and next to mix anhydrous Glauber's salt which is four point two times to the primary mixture in bulk and is crushed up into 65 mesh, then get new mixture which is called as ink seeping layer now;

Third, put two kinds of new mixture mentioned above into the material container (not showed) of different squeezing conduit 5,6, and heat the aforesaid mixture to a temperature of 110° C.˜120° C. by the heating part of the squeeze machine to make the mixture material become semiliquid.

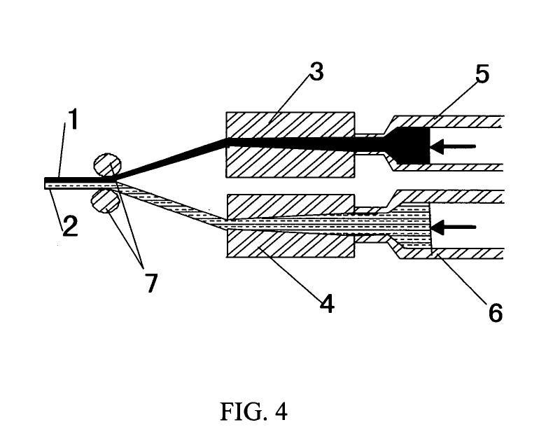

Referring to FIG. 4, the molding mould 3 connects to the squeezing exit of the conduit 5 and the molding 4 connects to the squeezing exit of the conduit 6. The material of the lettering layer and the ink seeping layer is squeezed out from the molding mould 3 and 4 respectively and delivered through the two platens which are drove by an electromotor. The top platen 7 turns deasil, but the other platen 7 turns anticlockwise. The two platens 7 roll the material of lettering layer and the ink seeping layer to make both two layers become one directly and to get the semi-manufactured goods of the seal material with the structure of the lettering layer 1 superposing the ink seeping layer 2 and both layers becoming one. In operation, the material of lettering layer and the ink seeping layer becomes cooler and cooler after it is squeezed out from the exit of the molding mould 3 and 4 respectively to be ready for rolled.

Marinate the seal patch material of the semi-manufactured goods for ninety-six hours in the hydrochloric acid liquor which is 1% in concentration. Dissolve the dissolubility stuffing of the seal material, and launder the semi-manufactured goods with water at normal temperature and next dry, then we can acquire the seal material related the present invention. In operation, adjust the sizes of the squeezing exit of the molding mould 3, 4 and the space between the two platens we can adjust and acquire different thickness of the lettering layer and ink seeping layer.

### EXAMPLE 12

First, mix polyolefin (or polymerized resin), photosensitive pigment auxiliary, antioxidant, nonionic surfactant and processing auxiliary to get primary mixture, and next to mix anhydrous Glauber's salt which is four times to the primary mixture in bulk and is crushed up into 800 mesh, then get new mixture which is called as lettering layer now;

Second, mix polyolefin (or polymerized resin), photosensitive pigment auxiliary, antioxidant, nonionic surfactant and processing auxiliary to get primary mixture, and next to mix anhydrous Glauber's salt which is five times to the primary mixture in bulk and is crushed up into 100 mesh, then get new mixture which is called as ink seeping layer now;

Third, get the patch material of the lettering layer and the ink seeping layer by squeezing or molding and put the material of both layers into the same molding mould to get the semi-manufactured goods of the seal material with the structure of both two layers superposing each other.

Then, dissolve, launder and dry as example 10 to get the seal material of the present invention. In operation, the temperature of molding is controlled between 115° C.±5° C., and the time of molding is limited for 10˜15 minutes. The molding mould is fixed on one molding machine and we can adjust the pressure of the molding mould in accordance with practical needs.

### EXAMPLE 13

First, mix polyolefin (or polymerized resin), photosensitive pigment auxiliary, antioxidant, nonionic surfactant and processing auxiliary to get primary mixture, and next to mix anhydrous Glauber's salt which is four times to the primary mixture in bulk and is crushed up into 800 mesh, then get new mixture which is called as lettering layer now;

Second, mix polyolefin (or polymerized resin), photosensitive pigment auxiliary, antioxidant, nonionic surfactant and processing auxiliary to get primary mixture, and next to mix anhydrous Glauber's salt which is five times to the primary mixture in bulk and is crushed up into 100 mesh, then get new mixture which is called as ink seeping layer now;

Third, the material of ink seeping layer and the material of lettering layer are laid in perpendicularity order and are leveled off respectively, and then are rolled to become one with the structure of one layer superposing the other layer in one mould; and

then, dissolve, launder and dry as example 10 to get the seal material of the present invention. In operation, the temperature of molding is controlled between 100□˜150□, and the time of molding is limited for 10˜20 minutes.

The content percentages of the primary mixture are measured as follows:

polyolefin (or polymerized resin) 70%˜90%;

photosensitive pigment auxiliary 0.1%˜5%;

nonionic surfactant 0.5%˜3%;

antioxidant 0.5%˜3%;

processing auxiliary 5%˜25%.

In operation, the aforesaid polyolefin or polymerized resin may be polyethylene, polypropylene, polybutene, or other polymerized resin; and photosensitive pigment auxiliary may be carbon black or other deep color paint; and nonionic surfactant may be fatty alcohol-poly-oxyethylene ether (e.g. peregal O-20, or alkylphenol ethoxy-lates (e.g. emulsifying agent OP), fatty acid-poly-oxyethylene ether (e.g. emulsifying agent A 10); and antioxidant may be antioxidant 246, antioxidant 2246, antioxidant 1010; and processing auxiliary may be stearic acid, olefin, and oleic acid-amide and so on.

In addition, the aforesaid anhydrous Glauber's salt and calcium carbonate both are dissolubility stuffing of the primary mixture. But it is apparent that the dissolubility stuffing may be one kind of potassium carbonate, magnesium carbonate, aluminum hydroxidek, magnesium hydroxidek, barium hydroxidek, potassium nitrate, sodium nitrate, potassium chloride and calcium chloride or the mixture of the compounds mentioned above; and correspondingly, the impregnant may be hydrochloric acid, sulfuric acid, carbonic acid, nitric acid and so on.

In a word, the present invention provides a kind of seal material with two layers structure, and makes use of the respective virtue of each layer. In addition, the present invention also provides a method of making the seal material mentioned above including the process of dissolving the dissolubility stuffing of the semi-manufactured goods of the seal material, thereby the seal material of the present invention has the virtue of high speed of ink seeping and good impression.

While there have been shown what are presently considered to be preferred embodiments of the invention, it will be apparent to those skilled in the art that various changes and modifications can be made herein without departing from the scope of the invention as defined by the appended claims. Accordingly, it is to be understood that the invention is not to be limited by the specific illustrated embodiment, but only by the scope of the appended claims.

What is claimed is:

1. A seal material comprising lettering layer and ink seeping layer which bonds each other together and becomes one directly.

2. The seal material as in claim 1, wherein said lettering layer provides jerkwater holes which are 3˜20 micron in diameter and said lettering layer is 75˜95 percent in the rate of stiletto; and
said seeping layer provides jerkwater holes which are 20˜150 micron in diameter and said lettering layer is 95˜99 percent in the rate of stiletto.

3. A method of making seal material comprising:
(1) mixing the seal framework material to acquire primary mixture, and adding the dissolubility stuffing which are 2˜4 times to said primary mixture in bulk and which comprises grains with the diameter of 200˜800 mesh to acquire the material of lettering layer;
(2) mixing the seal framework material to acquire primary mixture, and adding the dissolubility stuffing which are 3.5% times to said primary mixture in bulk and which comprises grains with the diameter of 30˜100 mesh to acquire the material of ink seeping layer;
(3) making said material of lettering layer and said material of seeping layer bond each other together and become semi-manufactured goods at some temperature;
(4) dissolving the aforesaid dissolubility stuffing with some impregnant; and
(5) drying said semi-manufactured goods.

4. The method of making seal material in claim 3, wherein said material of ink seeping layer and said material of lettering layer are separately carried into different conduits of the extrusion machine, and next are squeezed out to a mould, and then are squeezed out from one same meatus of the aforesaid mould and become one with the structure of one layer superposing and bonding the other layer together, and all the processes mentioned above are carried out at the temperature of 100˜130° C. before the aforesaid dissolubility stuffing is dissolved.

5. The method of making seal material in claim 3, wherein said material of ink seeping layer and said material of lettering layer are processed into patches respectively, and then are rolled to become one with the structure of one layer superposing and bonding the other layer together; and all the processes are carried out at the temperature of 100° C. to 130° C. before the aforesaid dissolubility stuffing is dissolved.

6. The method of making seal material in claim 3, wherein said material of ink seeping layer and the material of lettering layer are processed into patches respectively, and then are rolled to become one with the structure of one layer superposing and bonding the other layer together; and
all the processes are carried out at the temperature of 90° C. to 150° C. before the aforesaid dissolubility stuffing is dissolved, and
the process of rolling costs time from five to twenty minutes.

7. The method of making seal material in claim 3, wherein said material of ink seeping layer and said material of lettering layer are laid in perpendicularity order and are leveled off respectively, and then are rolled to become one with the structure of one layer superposing and bonding the other layer together in one mould; and
all the processes are carried out at the temperature of 110° C. to 150° C. before the aforesaid dissolubility stuffing is dissolved, and
the process of rolling to molding costs time from five to twenty minutes.

8. The method of making seal material in claim 3, wherein said semi-manufactured goods will be laundered with water before it is dried.

9. The method of making seal material in claim 3, wherein the aforesaid dissolubility stuffing is anhydrous Glauber's salt and the corresponding impregnant mentioned above is water.

10. The method of making seal material in claim 3, wherein the aforesaid dissolubility stuffing is calcium carbonate and the corresponding impregnant mentioned above is the liquor of hydrochloric acid.
